(19) United States
(12) Patent Application Publication
(10) Pub. No.: US 2025/0335244 A1
(43) Pub. Date: Oct. 30, 2025

(54) NEGOTIATING CONTRACTS FOR AGENT COOPERATION IN MULTI-AGENT SYSTEMS

(71) Applicant: DeepMind Technologies Limited, London (GB)

(72) Inventors: Yoram Bachrach, London (GB); Andrea Tacchetti, London (GB); Ian Michael Gemp, London (GB); János Kramár, London (GB); Mateusz Malinowski, London (GB); Kevin Robert McKee, London (GB)

(21) Appl. No.: 18/864,639

(22) PCT Filed: May 10, 2023
(86) PCT No.: PCT/EP2023/062432

§ 371 Date: Nov. 11, 2024

Related U.S. Application Data
(60) Provisional application No. 63/340,883, filed on May 11, 2022.

(51) Int. Cl. G06F 9/48; G06F 9/54

(52) U.S. Cl. CPC G06F 9/4887; G06F 9/54

(57) ABSTRACT

Methods, systems and apparatus, including computer programs encoded on computer storage media, for enabling agents to cooperate with one another in a way that improves their collective efficiency. The agents can modify their behavior by taking into account the behavior of other agents, so that a better overall result can be achieved than if each agent acted independently. This is done by enabling the agents to negotiate contracts with one another that restrict their respective actions.

### BACKGROUND

This specification relates to agent cooperation in multi-agent systems.

The systems use neural networks. Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes technologies which enable agents to cooperate with one another in a way that improves their collective efficiency. The agents can modify their behavior taking into account the behavior of other agents, so that a better overall result can be achieved than if each agent acted independently.

In one aspect there is described a computer-implemented method of controlling a first agent to perform a task in an environment in which the first agent interacts with one, two, or more other agents in the environment performing one or more other tasks.

The first agent, at each of a plurality of time steps, obtains a state representation characterizing the state of the environment and processes the state representation using an action selection subsystem to generate a policy output, determines predicted actions of the other agents using the state representation, and selects an action to perform using the policy output and dependent upon the predicted actions.

At one or more of the time steps the first agent negotiates a contract with a second agent, the contract defining a restriction on the actions that may be selected by the first agent and a restriction on the actions that may be selected by the second agent.

This involves the first agent determining whether to propose a contract by determining one or more scores that represent an expected value of the state of the environment to the first agent at a subsequent time step with and without the proposed contract. This is done by simulating effects of future actions of the first agent and of the other agents i) without the proposed contract and ii) taking into account the effect of the restriction on the actions in the proposed contract. The proposed contract is communicated to the second agent dependent on the score(s) and, in response to receiving an indication of acceptance of the proposed contract from the second agent, an action for the first agent to perform is selected taking into account the restriction on the actions of the first agent in the proposed contract.

Particular embodiments of the subject matter described in this specification can be implemented so as to realize one or more of the following advantages.

Equipping agents with the ability to negotiate contracts as described above facilitate agents learning to cooperate to perform their respective tasks. Agents equipped in this way may be able to perform a task that they might otherwise be unable to perform, or they may be able to perform a task more efficiently, for example faster or consuming fewer resources than would otherwise be the case. In general communicating agents outperform non-communicating agents, and there can be substantial gains through cooperation.

The described techniques facilitate agreeing on contracts that benefit both parties. For example, were a contract to benefit just the first agent the second agent would be unlikely to agree to the contract. Because the described techniques facilitate identifying contracts that benefit both parties the likelihood of beneficial cooperation amongst the agents is enhanced. An agent can also impose a sanction to discourage breaking an agreed contract. In implementations the agents are able to act simultaneously in the environment.

Implementations of the techniques do not rely on a central coordinating authority that could represent a single point of failure. Instead the described techniques can be implemented in a decentralized, e.g. peer-to-peer, setting. This facilitates deploying the techniques in a wide range of applications, and can also help provide robustness. Further, the amount of communication between agents to agree contracts can be relatively small.

The described techniques can be used in environments where the action space is very large, e.g. combinatorial. For example each agent may have a large number of possible actions that can be performed at each time step. This results in a vast space of potential contracts. The described techniques can be used effectively in such action spaces.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE FIGURES

FIG. 1 shows an example of a multi-agent system.

FIG. 2 is a flow diagram of an example process for controlling a first agent.

FIG. 3 is a flow diagram of a first example process for determining whether to propose a contract.

FIG. 4 is a flow diagram of a second example process for determining whether to propose a contract.

FIG. 5 is a flow diagram of an example process for selecting contracts to evaluate for proposing.

FIG. 6 illustrates benefits that can be achieved from use of the first example process.

FIG. 7 illustrates benefits that can be achieved from use of the second example process.

Like reference numbers and designations in the various drawings indicate like elements.

### DETAILED DESCRIPTION

This specification generally describes a computer-implemented method of controlling a first agent to perform a task in an environment in which the first agent interacts with one, two, or more other agents in the environment performing one or more other tasks. Operation of the other agents may be controlled by a computer-implemented method e.g. similar to that controlling the first agent, or some or all may be partly or wholly under human control.

In general the tasks may have the same character e.g. they may all be routing tasks, or they may all be scheduling tasks, or they may all be manufacturing tasks. The other tasks may be the same as, or different to, the task of the first agent. The tasks performed by the agents may contribute to achieving a common goal. In typical implementations the ability of the first agent to perform the task in the environment is affected by the one or more other agents performing the one or more other tasks in the environment. Some example tasks are described in more detail later.

The first agent, and in implementations the other agents, are enabled to agree on contracts regarding joint plans, and in this way can outperform agents that operate independently. A contract imposes restrictions on the actions of the agents that enter into it, and agreeing on a contract involves negotiation, i.e. communication between agents. A contract can reflect a balance between cooperation and competition, and the described techniques facilitate operating in many real-world domains where agents interact, i.e. where the actions of one agent affect another, and where the goals of the agents may only partially align.

Such multi-agent systems are common in the real world and include, for example, systems of robots or autonomous or semi-autonomous vehicles that interact whilst performing a task, such as a system of warehouse robots; factory or plant automation systems; and computer systems. Thus, as examples, the agents may include robots or vehicles, items of equipment in a factory or plant, or software agents in a computer system e.g. that control the allocation of tasks to items of hardware or the routing of data on a communications network.

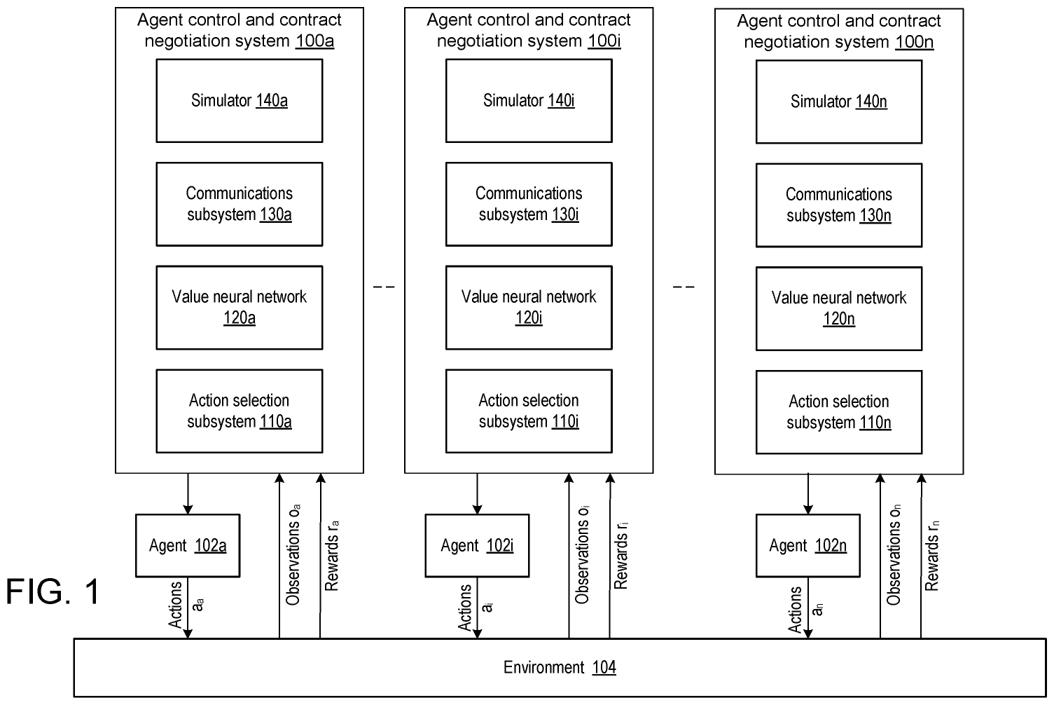

FIG. 1 shows an example of a multi-agent system comprising agents 102a . . . n, each controlled by a respective agent control and contract negotiation system 100a . . . n. Each agent control and contract negotiation system 100a . . . n may be implemented as one or more computer programs on one or more computers in one or more locations. In the illustrated example each of the agents is computer-controlled, but in other examples one or more of the agents may be human-controlled.

The agents 102a . . . n operate in a common environment 104 each to perform a respective task. The tasks performed by the respective agents may be the same or they may be different to one another. In general, how one agent performs its task affects how another of the agents is able to perform its task. For convenience the following description refers to the agent control and contract negotiation system 100a of the agent 102a (also referred to as the first agent); in implementations the other agent control and contract negotiation systems are similar.

At each of multiple action-selection time steps the agent control and contract negotiation system 100a selects an action aₐ to be performed by agent 102a in response to a state representation characterizing a state of the environment. In implementations the state representation is derived from an observation Oa of the state of the environment. For example, the observation may include an image of the environment and/or other sensor data e.g. data representing a position, state or configuration of one or more of the agents, or a state or configuration of the environment including objects in the environment; or generally input data from the environment. In some implementations the observation may be processed, e.g. by a neural network, to obtain the state representation; in some implementations the observation itself may be used as the state representation.

The agent control and contract negotiation system 100a may also receive a reward rₐ as a result of performing the action aₐ. In general the reward is a numerical value, i.e. a scalar, and may be based on any event or aspect of the environment. For example, the reward rₐ may indicate whether the agent 102a has accomplished the task, or progress of the agent 102a towards accomplishing the task (e.g., a physical configuration of one or more objects, or navigation to a target location in the environment).

In implementations the agent control and contract negotiation system 100a includes an action selection subsystem 110a that is used to select the actions performed by the agent 102a. The action selection subsystem 110a is configured to process a state representation characterizing a state of the environment at a (current) time step, e.g. derived from an observation of the environment, to generate a policy output for selection of an action to be performed by the agent. As previously described, each of the agents 102 may have an associated action selection subsystem 110.

There are many ways in which the policy output can be used to select actions. For example the policy output may define a probability distribution over a set of actions that can be performed by the agent. An action may then be selected using the probability distribution, e.g. by sampling from the probability distribution or selecting an action with the highest probability. The policy output may parameterize such a probability distribution, or it may define the probability distribution as a set of scores according to which an action can be selected, e.g. a score for each action of a set of possible actions. As another example the policy output can define an action directly, e.g. by identifying a speed or torque for a mechanical action. In general an action may be continuous or discrete; optionally a continuous action may be discretized. An action may comprise multiple individual or primitive actions to be performed at a time step e.g. a mixture of continuous and discrete actions. In some implementations the policy output may comprise multiple outputs, e.g. from multiple heads on a neural network, for selecting multiple actions at a particular time step.

In general any type of action selection subsystem may be used for the action selection subsystem 110a. In some implementations, but not essentially, the action selection subsystem 110a includes an action selection policy neural network. For example the action selection subsystem may use an action selection policy neural network configured to process the state representation characterizing the state of the environment, in accordance with action selection policy neural network parameters, to generate an action selection neural network output that may be the policy output. In some implementations the action selection neural network output of an action selection policy neural network may be used indirectly to generate the policy output, e.g. by using the action selection policy neural network to simulate possible futures that are used to determine the policy output. For example the action selection subsystem may implement a “Sampled Best Response” algorithm as described in Anthony, Eccles, Tacchetti, Kramár, Gemp, Hudson, Porcel, Lanctot, Julien, Everett, Singh, Graepel, and Yoram, arXiv: 2006.04635v4.

As described further later, the agent control and contract negotiation system 100a determines predicted actions of the other agents, in particular using the state representation. In implementations the action selection subsystem 110a, or a version of the action selection subsystem 110a (e.g. with different values of learnable parameters, e.g. from an earlier training iteration), is used to predict the actions of the other agents 102b . . . n, e.g. to predict actions selected by the action selection subsystems 110b . . . n of the other agents.

Predicted actions of the other agents may be determined in various ways, and how this is done can depend on the particular technological application. For example in one approach the agents have the same or corresponding task goal, such as to navigate to a target location or to achieve a particular state or configuration of the environment, e.g. of an object in the environment. Then the state representation, derived from the observation, Oa, of the environment and processed by the action selection subsystem to predict an action for a particular agent, may represent the environment as it is relevant to that particular agent. For example if the task is to navigate to a target location the state representation may comprise a representation of a position of that particular agent. In other cases, e.g. where the environment is a computing or communications environment, the state representation may comprise a representation of a state or configuration of the computing or communications environment as it is relevant to that agent. In some other implementations the state representation processed by the action selection subsystem to predict an action for a particular agent may be obtained separately to the observation, oa, e.g. from the particular agent.

As another example, the action selection subsystem 110a may be goal-conditioned, e.g. it may also process an input identifying the task to be achieved. In that case the first agent may obtain information, e.g. from another agent, defining a goal of the other agent, and process that and data from the observation, Oa, to predict an action of the other agent. As a further example, the agent control and contract negotiation system 100a may maintain a copy of the action selection subsystem of one or more of the other agents, and use that to predict an action taken by the other agent(s).

In implementations the agent control and contract negotiation system 100a also includes a value neural network 120a configured to process the state representation, in accordance with value neural network parameters, to determine a state value. The state value can define an expected return for the first agent from the state of the environment characterized by the state representation. In some implementations the value neural network 120a determines a state value for each of the agents, e.g. by processing the state representation and providing the value neural network 120a with a separate “head” for each agent; or in some other way, e.g. by using the same the value neural network for each of the agents, or by obtaining a copy of the value neural network of each of the other agents.

In general the expected return from a state of the environment may comprise an estimate of a cumulative, time discounted sum of rewards for performing a (the) task, starting from the state. The rewards may include negative rewards i.e. costs. In implementations each of the agents has a value neural network. Generally, implementations of the techniques described herein can attempt to maximize the expected return for the first agent 102a and/or can attempt to minimize a corresponding cost for the first agent 102a. However the techniques described herein facilitate cooperation amongst agents so that an improved return can be achieved for all the agents, including the first agent 102a.

In some implementations the action selection subsystem 110a of each agent, e.g. the action selection policy neural network, and the value neural network of each agent, has been pre-trained to perform the task, and the described techniques use these pre-trained neural networks for negotiating a contract. There are many approaches that can be used for such pre-training and the techniques described herein do not rely on any particular method. Merely as some examples, one or more of imitation learning e.g. behavioral cloning, regret minimization, and reinforcement learning (based on the rewards) may be used.

As one particular example imitation learning can be used, followed by reinforcement learning, to train and improve the action selection subsystem 110a and the value neural network 120a of each agent. Such an approach is described in Anthony et al, arXiv: 2006.04635v4 (ibid). Broadly this can involve, for each of a plurality of training iterations: generating training data for a training iteration by controlling an agent with an improved policy that selects actions in response to input state representations by performing a best response computation using (i) a candidate policy generated from a policy neural network as of one or more preceding iterations, and (ii) a candidate value neural network. The candidate value neural network can be generated from value neural networks as of each of the one or more preceding iterations. The policy neural network value neural network can be updated at each of the plurality of training iterations by training these on the training data.

In some implementations of the described techniques learnable parameters of the action selection subsystem, e.g. of the action selection policy neural network, and of the value neural network may be frozen. In some other implementations the learnable parameters of the action selection subsystem, e.g. of the action selection policy neural network, and of the value neural network can be trained, e.g. fine-tuned, during operation of the processes described herein.

In general the action selection subsystem 110a, e.g. the action selection policy neural network, and the value neural network 120a can have any suitable architecture. For example the action selection policy neural network and the value neural network 120a may include, e.g., one or more feed forward neural network layers, one or more convolutional neural network layers, one or more attention neural network layers, or one or more normalization layers. A neural network may be pre-trained by backpropagating gradients of an objective function to update values of the neural network parameters, such weights, e.g. using an optimization algorithm such as Adam. As an example a reinforcement learning objective function may be based on the rewards received, e.g. on a Bellman error or on a policy optimization objective.

The agent control and contract negotiation system 100a further includes a communications subsystem 130a for inter-agent communications. In implementations each agent has such a system and this enables the agents, more specifically the agent control and contract negotiation systems of the agents, to communicate with one another to negotiate a joint plan of action. This generally involves negotiating an agreement, or contract, with one or more other agents in accordance with a protocol, as described in more detail later. In general a contract defines a restriction over the actions each of the agents may take in the future. For example such a contract can defining a restriction on the actions that may be selected by the first agent and a restriction on the actions that may be selected by another, second agent. The communications subsystem 130a may implement any form of communication, e.g. wired or wireless communication, point-to-point or point-to-multipoint; it may implement low level data communications, or it may use natural language.

Implementations of the agent control and contract negotiation system 100a also include a simulator 140a, configured to simulate effects of future actions of the agents, in particular of the first agent 102a and of the other agents. The simulator 140a processes the state representation characterizing the state of the environment at the current time step, and supposed actions of the agents, e.g. a candidate action of the first agent and predicted actions of each of the other agents. The simulator 140a determines a predicted subsequent, e.g. next, state of the environment, in particular a state representation characterizing the predicted next state of the environment. Thus the simulator 140a can, for example, predict the effect of a contract by simulating effects of future actions of the first agent and of the other agents i) without the proposed contract and ii) taking into account the effect of the restriction on the actions in the proposed contract.

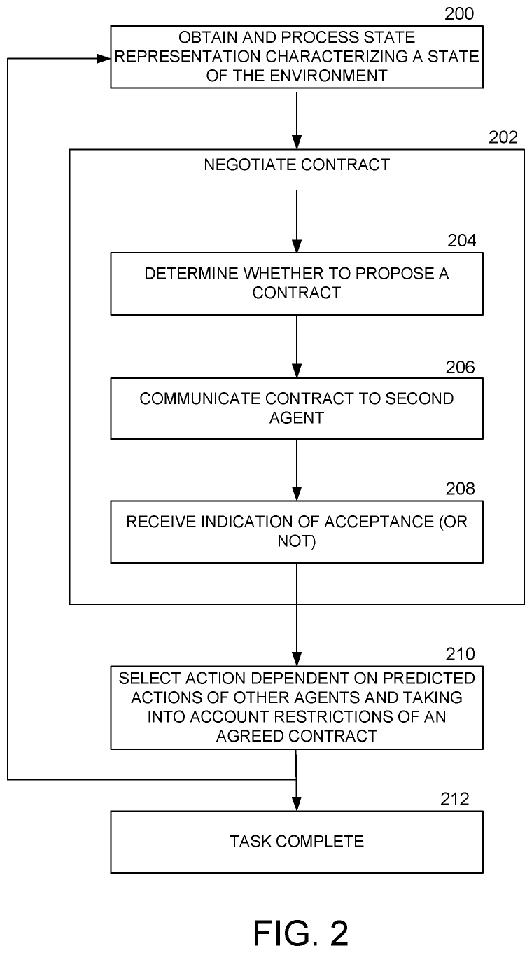

FIG. 2 is a flow diagram of an example process for controlling a first agent, e.g. agent 102a, to perform a task in an environment in which the first agent interacts with one or more other agents performing one or more other tasks. The process of FIG. 2 may be implemented on one or more computers in one or more locations, e.g. on the agent control and contract negotiation system 100a of FIG. 1 and optionally on each of the other agent control and contract negotiation systems.

At each of a plurality of time steps the first agent 102a obtains a state representation characterizing the state of the environment at the current time step, e.g. from an observation of the environment, and processes this using the action selection subsystem 110a for the agent to generate the policy output for the agent (step 200). The state representation is also used to predict actions of the other agent(s), and the policy output and these predicted actions are used to select an action for the first agent to perform.

In general the action of the first agent is selected dependent upon the predicted actions of the other agent(s). For example the action may be selected from amongst candidate actions and by determining the state value of a next state of the environment for each candidate action given the predicted actions of the other agent(s). The action may be selected based upon the expected return from the next state of the environment. Each of the other agents may similarly select an action in this way.

A next state of the environment may be determined from a simulation of the environment, e.g. using simulator 140a to process the candidate action and predicted actions. An expected value of a state of the environment, e.g. the expected return from the next state of the environment, may be determined by using the value neural network 120a to process a state representation characterizing the state of the environment.

In implementations the process includes, at one or more of the time steps, the first agent negotiating a contract with a second agent, where the second agent is one of the other agents (step 202). The contract defines a restriction on the actions that may be selected by the first agent and a restriction on the actions that may be selected by the second agent.

In implementations negotiating the contract comprises the first agent determining whether to propose a contract (step 204) by determining values of one or more scores that represent an expected value of the state of the environment to the first agent at a subsequent time step with and without the proposed contract, e.g. using an SVE value estimate as described later. This can be performed by simulating effects of (potential) future actions of the first agent and of the other agents, in implementations of all the agents, i) without the proposed contract and ii) taking into account the effect of the restriction on the actions in the proposed contract. The potential future actions may be determined using the action selection subsystem, or a version of this e.g. with different value of the learnable parameters, and the effects of the future actions may be evaluated using the value neural network 120a to determine the expected returns from a next state of the environment, e.g. as determined by simulator 140a. In implementations the method uses the score(s) to determine whether to propose the contract, in some implementations whether or not to propose any contract, in some implementations whether or not to propose a particular contract.

The proposed contract may then be communicated to the second agent dependent on the score(s), e.g. when the one or more scores indicate a greater expected return with the proposed contract than without it (step 206).

The proposed contract may or may not be accepted by the second agent. Absent acceptance non-acceptance may be assumed, or non-acceptance may be communicated explicitly (step 208).

When the contract is accepted by the second agent, e.g. as indicated by a communication from the second agent to the first agent, the process selects an action for the first agent to perform taking into account the restriction on the actions of the first agent in the contract (step 210). Correspondingly, the second agent may select actions taking into account the restriction on the actions that can be selected by the second agent. The second agent may determine whether to accept the proposed contract by determining an expected return (for the second agent) with and without the proposed contract, e.g. by simulating the effects of restricted and unrestricted actions as described for the first agent. When the proposed contract is not accepted the first agent may select actions in any suitable manner based on the policy output, unconstrained by the proposed contract with the second agent. Nonetheless the actions may be constrained by one or more contracts with other agent(s), if present.

The process continues by obtaining and processing a state representation characterizing the environment at the next time step (step 200), until the task is complete (step 212) according to any suitable criterion.

Where there are more than two agents present the process of FIG. 2 may be used by the first agent to propose a contract to each of the other agents (although it is not necessary for all the other agents in the system to be able to agree a contract). In implementations, if there are multiple agreed contracts action the restrictions of all the contracts agreed by the first agent may be applied to the actions of the first agent.

As described in more detail later, there are various protocols that may be used to negotiate, i.e. communicate and agree on, contracts. As examples, a “Mutual Proposal” protocol places restrictions on the actions of both the first and second agents, and a “Propose-Choose” protocol enables the first and second agents each to agree on taking a specific respective action. The particular required or disallowed actions can depend upon the application. For example in the “Mutual Proposal” protocol there may, e.g. be a restriction on actions that would result in a collision or conflict, or partial collision or conflict, in the environment, or a risk of this; or a restriction on actions that would support a third agent. In the “Propose-Choose” protocol, where there is more than one other agent a single “second agent” may be selected as a partner to agree a contract with, e.g. one offering the most favorable contract, or greatest expected return, according to a score value.

In some implementations of the process the first agent may receive one or more proposed contracts from the second agent or others of the agents. Then negotiating the contract may involve both the first agent and the second agent accepting a proposed contract before the contract is used for restricting the actions of the first agent (and of the second agent). For example in some implementations of the “Propose-Choose” protocol both the first and second agents need to choose (accept) the same contract for it to be implemented. In some implementations the first agent may accept (may be able to indicate that they are willing to accept) two contracts, the proposed contract proposed by the first agent and a proposed contract from the second agent. Then either contract may be implemented to restrict actions, e.g. the contract with the greatest expected return.

Merely as examples, when an action is unconstrained it may be determined directly from the output of the action selection policy neural network or it may be determined using a “Sampled Best Response” (SBR) algorithm (ibid). For example denoting a current action selection policy (e.g. as defined by its action selection policy neural network) of agent i, as

$${π}_{i}^{c} ,$$

and the action selection policies of the other agents as π^{b} (e.g. defined by the same or a different action selection policy neural network), denoting a vector of other agent actions samples from

$${π}_{- i}^{b} as {a}_{- i} ∼ {π}_{- i}^{b}$$

(where the subscript −i denotes all the agents except for agent i), and denoting a sample of M such action vectors as

$$A = {a}_{- i}^{1} , ... , {a}_{- i}^{M} ∼ {π}_{- i}^{b} ,$$

an estimated future reward, i.e. action value estimate

$${Q}_{i}^{{A}_{- i}} ( s , {c}^{j} )$$

can be defined for a candidate action c^{j} of agent i and a state of the environment s as:

$${Q}_{i}^{{A}_{- i}} ( s , {c}^{j} ) = \frac{1}{M} {\sum }_{m = 1}^{M} {Q}_{i}^{{a}_{- i}^{m}} ( s , {c}^{j} ) = \frac{1}{M} {\sum }_{m = 1}^{M} {V}_{i} ( T ( s , ( {c}^{j} , {a}_{- 1}^{m} ) ) )$$

where T(s, a) is a transition function of the state of the environment given a vector of (all) agent actions a, represented by the simulator 140; and Vᵢ(s) is a state value, e.g. from value neural network 120. The action value estimate

$${Q}_{i}^{{A}_{- i}} ( s , {c}^{j} )$$

can be determined for a number of, e.g. many, candidate actions sampled from

$${π}_{i}^{c} ( s )$$

and one of these, e.g. the candidate action with the highest value estimate, can be selected as the action to be performed.

As described above, determining whether to propose a contract can involve determining values of one or more scores that represent an expected value of the state of the environment to the first agent at a subsequent time step to the current time step.

In implementations determining the expected value of the state of the environment to the first agent at the subsequent time step involves sampling one or more possible actions of the first agent at the time step, using the action selection subsystem 110a of the first agent. For each of the one or more actions and for each of the other agents the process can then sample a plurality of possible actions of the other agent at the time step, and use the value neural network to determine the state value for a predicted new state of the environment (at the subsequent time step) determined by the sampled actions of the agents.

As previously described, the plurality of possible actions of the other agent may be determined using the action selection subsystem of the first agent, or a version thereof, e.g. by processing the current state representation using the action selection subsystem. The predicted new state of the environment can be determined by using the simulator 140a to simulate the effects of the possible actions e.g. to determine the state representation for the predicted new state of the environment. Simulating the effects of the future actions may comprise averaging the state value for each predicted new state (as determined by the possible actions) over the sampled actions for each of the other agents to determine the expected value of the state of the environment to the first agent, in particular for each of the one or more sampled possible actions of the first agent.

Simulating the future actions of (all) the agents may comprise, for each agent, selecting a set of one or more candidate actions for the agent using the action selection subsystem and/or, where the proposed contact applies to the agent, by applying the restriction on the actions in the proposed contract. In some implementations the proposed contract defines a restricted set of actions; in some implementations the proposed contract defines a single action to be performed by an agent such as the first agent or the second agent.

In some implementations a Monte-Carlo estimate of the value of agent i taking action aᵢ is calculated by sampling M partial action profiles

$${A}_{- i} = {a}_{- i}^{1} , … , {a}_{- i}^{M} ∼ {π}_{- i} ,$$

where a₋ᵢ˜π₋ᵢ denotes sampling actions for all the agents except agent i from their respective action selection policies π₋ᵢ of the respective action selection subsystems (which are available in some form to agent i), so that the full action profile is (a, a₋ᵢ). An estimate of the value of agent i taking action aᵢ,

$${\hat{Q}}_{i}^{{A}_{- i}} ( s , {a}_{i} ) ,$$

referred to later as a Simulation Action Value Estimate (SAVE), can then be calculated as:

$${\hat{Q}}_{i}^{{A}_{- i}} ( s , {a}_{i} ) = \frac{1}{M} {\sum }_{m = 1}^{M} {Q}_{i}^{{a}_{- i}^{m}} ( s , {a}_{i} )$$

where

$${Q}_{i}^{{a}_{- i}} ( s , {a}_{i} ) = {V}_{i} ( T ( s , ( a , {a}_{- i} ) ) ) .$$

A SAVE estimate (and the STAVE estimate described later) may similarly be calculated for agent j using Vⱼ (T (s, (a, a₋ᵢ))) instead of Vᵢ (T (s, (a, a₋ᵢ)) where Vⱼ (·) can be determined using the value neural network of agent i (assuming this to be a sufficiently useful approximation), or a version of this, e.g. with different learnable parameters such as weights, or by having access to, or to a copy of, the value neural network of agent j.

A Simulation Value Estimate (SVE), e.g. for agent i, based on a restricted set of possible actions, can be determined by averaging over actions of the agents sampled from the restricted policies. As an example, for a contract denoted D=(Rᵢ, Rⱼ) where the action selection policy of the action selection subsystem of agent i, πᵢ is restricted to a set of actions Rᵢ, and that of agent j, πⱼ is restricted to a set of actions Rⱼ, the average may be taken over actions sampled from D. This value estimate may be written as

$${\hat{V}}_{i}^{A} ( s ) = \frac{1}{M} {\sum }_{m = 1}^{M} {Q}_{i} ( s , {a}^{m} ) ,$$

where each a^{m} is a full action profile, i.e. including actions for all the agents, a^{m}˜π^{D} where ˜π^{D} denotes sampling from the restricted set of actions for agents i and j and sampling from the unrestricted policies for the other agents, and A=a¹, . . . , a^{M}˜π^{D}, taking M Monte Carlo samples. A restricted set of actions may be sampled by sampling from an unrestricted policy and re-sampling when a sampled action falls outside the restriction Rᵢ (or Rⱼ). The SVE value estimate may be used to determine the expected value of the state of the environment to the first agent, when the actions of the first and second agent are restricted by a proposed contract.

Conveniently, but not essentially, given a neural network capturing a policy πᵢ and a restricted action set Rᵢ, an action can be sampled from the restricted policy

$${π}_{i}^{{R}_{i}} ( s )$$

(which can also be denoted π^{D}) by masking the logits of all actions not in Rᵢ e.g. by setting the weight of all actions not in Rᵢ to zero before the final softmax layer.

A Simulation Two-Action Value Estimate (STAVE), can also be determined that takes into account the combined effects of an action aᵢ for agent i and an action aⱼ for agent j, by averaging over the actions of the other agents as sampled from their respective policies. This can be done by taking M samples of actions

$${a}_{- \{ i , j \}}^{m}$$

for all the agents except for agents i and j,

$${A}_{- \{ i , j \}} = {a}_{- \{ i , j \}}^{1} , … , {a}_{- \{ i , j \}}^{M} ,$$

and using the full action profile,

$$( {a}_{i} , {a}_{j} , {a}_{- \{ i , j \}}^{m} ) ,$$

to estimate of the value of the next state

$${\hat{Q}}_{i}^{A} ( s , ( {a}_{i} , {a}_{j} ) ) = \frac{1}{M} {\sum }_{m = 1}^{M} {Q}_{i}^{{a}_{- \{ i , j \}}^{m}} ( s , ( {a}_{i} , {a}_{j} ) ) .$$

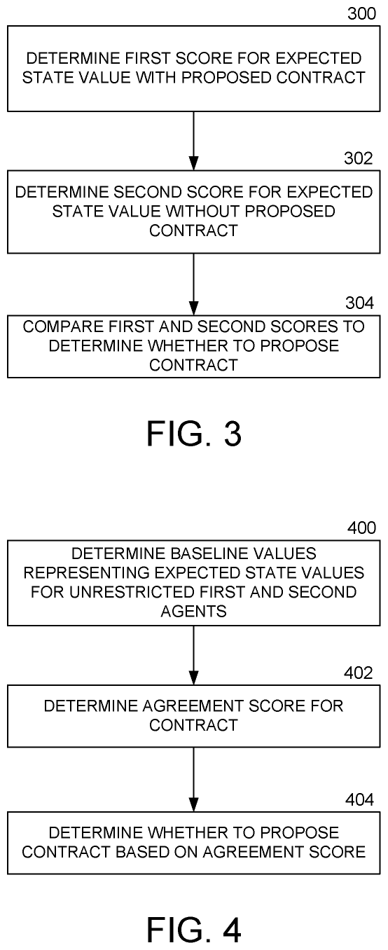

FIG. 3 is a flow diagram of an example process for determining whether to propose a contract, in implementations of the process using a “Mutual Proposal” protocol. The process of FIG. 3 may be implemented on one or more computers in one or more locations, e.g. on the agent control and contract negotiation system 100a of FIG. 1, and optionally on each of the agent control and contract negotiation systems.

In some implementations of the process the contract is a “generic” contract that defines a class of actions that define the same or corresponding restrictions on the actions that may be selected by both the first agent and the second agent. As an example, corresponding restrictions on the actions may define that one agent e.g. the first agent, is prohibited from moving into space occupied by another agent, e.g. the second agent. That is the restrictions may correspond but the specific actions that are restricted may differ. Such a contract may be denoted D_{i,j}=(Rᵢ, Rⱼ).

The example process involves determining a first score that represents an expected value of the state of the environment to the first agent at a subsequent time step, with the proposed contract (step 300); and determining a second score that represents an expected value of the state of the environment to the first agent at a subsequent time step, without the proposed contract (step 302). The first score and the second score may then be compared and a result of the comparison used to determine whether to propose the contract, e.g. communicating the proposed contract when the first score exceeds the second score (step 304). In broad terms, the first agent proposes a contract when the agent expects to achieve greater utility when the contract is agreed, and otherwise refrains from proposing the contract. As an example the first and second scores may each comprise a Simulation Value Estimate (SVE) as described above.

The first agent may propose such a contract to each of the other agents, e.g. using the process of FIG. 3, and may agree to multiple generic contracts, in which case the action restrictions of all the agreed contracts are applied.

In some implementations the first and second agents only accept such a “Mutual Proposal” contract if they each propose a contract defining a restricted set of actions to the other, i.e. if they mutually agree to restrict their actions. If no agreement is reached each agent is free to select an action unrestricted by the proposed contract (though possibly restricted by contracts agreed with other agents). If agreement is reached actions are selected by the first and second according to the agreed restrictions.

FIG. 4 is a flow diagram of an example process for determining whether to propose a contract, in implementations of the process using a “Propose-Choose” protocol. The process of FIG. 4 may be implemented on one or more computers in one or more locations, e.g. on the agent control and contract negotiation system 100a of FIG. 1, and optionally on each of the agent control and contract negotiation systems.

In some implementations the contract defines specific actions that must be taken by the first agent and the second agent. For example the contract may define a first action that must be selected by the first agent and a second action that must be selected by the second agent, i.e. each agent is restricted to a single action under the contract. A “Propose-Choose” protocol may then be used to determine which contracts (actions) to propose during a propose phase. The agent can choose from all the contracts (actions) that involve them, either contracts they proposed or contracts proposed to them. The group of all the contracts involving, e.g., the first agent, may be referred to as contracts On The Table for the first agent.

In some implementations of the “Propose-Choose” protocol two agents may only reach agreement, i.e. accept a contract, if they choose the same contract, e.g. if both choose D^{i→j} or both choose D^{j→i}, where D^{i→j} denotes a contract that agent i proposes to agent j, and vice-versa. In some implementations an agent may indicate that they are willing to accept either of D^{i→j} and D^{j→i} (if the agents rank them in a different order one may be selected randomly). With n agents each can potentially propose, and receive, n-1 contracts, and thus a first agent wishing to reach an agreement with a second agent is competing with the other agents. If the first agent proposes a contract that is mostly beneficial to itself the second agent is unlikely to choose that contract, and implementations of the described protocol take account of which contracts other agents are likely to accept.

In implementations the one or more scores used to determine whether to propose a contract comprise an agreement score that represents an expected value of the state of the environment to both the first agent and the second agent at the subsequent time step when the first agent and the second agent respectively select the first action and the second action (actions of the other agents, if any, may be unrestricted).

Referring to FIG. 4, at step 400 the process involves determining respective first and second baseline values that represent the expected value of the state of the environment to, respectively, the first agent and the second agent at a subsequent time step, without restricting the second agent to the second action and without restricting the first agent to the first action. The expected value of the state of the environment to the first agent, and to the second agent, at the subsequent time step, may be determined using the value neural network, e.g. it may comprise the state value from the value neural network or an average of state values.

The process then determines the agreement score using (i.e. with respect to) the baseline values (step 402), and determines whether to propose the contract based on the agreement score (step 404).

In implementations multiple candidate contracts may be evaluated and a candidate contract with the highest agreement score is proposed. That is, the process may include determining the proposed contract for the second agent by determining a plurality of candidate proposed contracts and selecting a candidate proposed contract based on agreement scores for the candidates, e.g. by selecting a candidate proposed contract with the highest agreement score as the proposed contract.

In some implementations the agreement score comprises a product of i) a difference between the expected value of the state of the environment to the first agent at the subsequent time step when the first agent and the second agent respectively select the first action and the second action (d₁), and the first baseline value

$$( {d}_{1}^{0} ) ,$$

and ii) a difference between the expected value of the state of the environment to the second agent at the subsequent time step when the first agent and the second agent respectively select the first action and the second action (d₂), and the second baseline value

$$( {d}_{2}^{0} ) .$$

For example the agreement score may be determined as

$${( {d}_{1} - {d}_{1}^{0} )}^{+} {( {d}_{2} - {d}_{2}^{0} )}^{+} ,$$

where (·)⁺ denotes max (·,0). In implementations the agreement score is equal to or greater than zero.

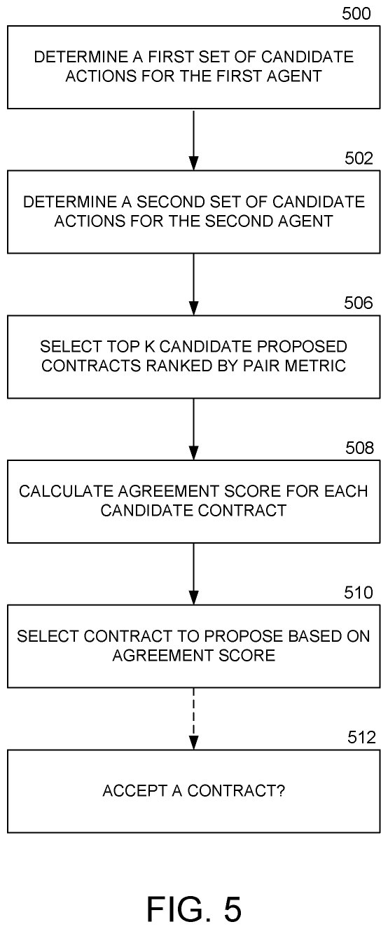

In some implementations the (highest) agreement score approximates a so-called “Nash Bargaining Score” or “Nash Bargaining Solution” (described in, e.g., J. F. Nash, “The bargaining problem,” in The Essential John Nash, pp. 37-48, Princeton University Press, 2016). Determining the agreement score in this way facilitates identification of contracts that are mutually beneficial to the first and second agents relative to having no contract. In conjunction with the method of selecting a contract described below with reference to FIG. 5, it also provides an approximation to Pareto optimality (where, as between the two agents, neither agent selects a contract if they can find another contract that has a higher utility to them), and symmetry (in expected utility to the two agents).

In some implementations the first baseline value comprises the expected value of the state of the environment to the first agent at the subsequent time step when the first agent selects the first (required) action and the action selected by the second agent is unrestricted. The second baseline value may comprise the expected value of the state of the environment to the second agent at the subsequent time step when the second agent selects the second (required) action and the action selected by the first agent is unrestricted.

In some implementations determining first and second baseline values takes account of whether contracts may be agreed between other pairs of agents than the first and second agent. This can be done by simulating negotiation processes of the other agents. Thus determining the first baseline value may comprise, for each pair of agents except for the pair comprising the first agent and the second agent, identifying whether they would agree a contract for the subsequent time step. This may be done as previously described for the first and second agent. When they would agree a contract, the first baseline value may be determined as the expected value of the state of the environment to the first agent at the subsequent time step as if the agreed contract for the pair was in place. Similarly determining the second baseline value may comprise, for each pair of agents except for the pair comprising the first agent and the second agent, identifying whether they would agree a contract for the subsequent time step. When they would agree a contract the second baseline value may be determined as the expected value of the state of the environment to the second agent at the subsequent time step as if the agreed contract was in place. As previously described the expected value of the state of the environment may be determined by processing the state of the environment at the subsequent time step, e.g. as determined by a simulator, using the value neural network 120. In general the expected value may be determined by Monte Carlo sampling over possible actions of the agents, e.g. as determined by the action selection subsystem, to obtain an average.

FIG. 5 is a flow diagram of an example process for selecting contracts to evaluate for proposing as described above, e.g. in a “Propose-Choose” protocol. The process of FIG. 5 may be implemented on one or more computers in one or more locations, e.g. on the agent control and contract negotiation system 100a of FIG. 1, and optionally on each of the agent control and contract negotiation systems.

An aim of the process of FIG. 5 is to be able to propose a contract that approximates the Nash Bargaining Solution. One difficulty is that the action space for the multiple agents 102a . . . n is combinatorial, and may be enormous, e.g. greater than 1020, and the space of possible contracts grows quadratically with this as it combines actions of the first and second agents. One way to address this is by sampling many actions from the action selection policies of the first and second agents. Such an approach can involve determining the proposed contract for the second agent by determining a plurality of candidate proposed contracts, and then selecting one of the candidate proposed contracts as the proposed contract.

Determining the candidate proposed contracts may comprise determining a first set of candidate actions for the first agent by processing the state representation at the current time step using the action selection subsystem to generate the policy output for the first agent (step 500). Determining the candidate proposed contracts may also comprise (the first agent) determining a second set of candidate actions for the second agent e.g. by processing the state representation at the current time step using the, or a version of the, action selection subsystem to generate the policy output for the second agent (step 502). The process may then generate pairs of actions comprising a first candidate action from the first set of candidate actions and a second candidate action from the second set of candidate actions (step 504).

The candidate proposed contracts may then be determined by selecting a set of candidate pairs of actions by ranking the pairs of actions according to a pair metric, and selecting the K highest ranked pairs of actions (step 506). Each candidate proposed contract may comprise one of the candidate pairs of actions.

The pair metric for a pair of actions may comprise a combination, e.g. sum, of the expected value of the state of the environment to the first agent at the subsequent time step when the first agent performs the first candidate action in the pair of actions, and the expected value of the state of the environment to the second agent at the subsequent time step when the second agent performs the second candidate action in the pair of actions. The combination, e.g. sum, may be a weighted combination to weight a value of the proposed contract to the second agent, e.g. to adjust a likelihood of acceptance of a proposed contract. The expected values of the state of the environment to the first and second agents may be scaled to approximately match one another.

An agreement score can then be calculated for each of the candidate proposed contracts (step 508), and one of the candidate proposed contracts can then be selected as the proposed contract based on the calculated agreement scores for the candidate proposed contracts, e.g. by selecting a contract with a highest agreement score (step 510).

Optionally the process can also include the first agent determining whether itself to accept the contract that the first agent proposed to the second agent; or whether to accept an incoming contract proposed by the second agent or one of the other agents (step 512). For example, this may involve the first agent determining one or more scores as previously described, e.g. an agreement score, for the proposed or incoming contract, and determining whether to accept the proposed or incoming contract based on the determined score(s). In some implementations the first agent chooses from the contracts On The Table for them, selecting a single other agent to agree a contract with.

As a particular example the process may generates multiple candidate proposed contracts by sampling a set cᵢ of N candidate actions for agent i.

$${c}_{i}^{1} , … , {c}_{i}^{N} ,$$

nom policy πᵢ, and a set cⱼ of N candidate actions for agent j,

$${c}_{j}^{1} , … , {c}_{j}^{N} ,$$

from policy πⱼ, determining the Cartesian product cᵢ×cⱼ, and selecting the top K ranked by a pair metric as described above.

A value of the pair metric may be determined assuming that the other agents (if any) are unrestricted and selecting actions according to an unrestricted policy profile

$${π}_{- \{ i , j \}}^{b} ,$$

from which M action profiles may be drawn B=(b¹, . . . , b^{M}); b¹, . . . , b^{M}˜π^{b}. The pair metric for an action cᵢ may comprise a weighted sum of the value of the next state of the environment to agent i,

$${\hat{Q}}_{i}^{{B}_{- i}} ( s , {c}_{i} ) ,$$

and to agent j,

$${\hat{Q}}_{j}^{{B}_{- i}} ( s , {c}_{i} )$$

The value of

$${\hat{Q}}_{j}^{{B}_{- i}} ( s , {c}_{i} ) .$$

may be selected to be on a similar scale ro

$${\hat{Q}}_{i}^{{B}_{- i}} ( s , {c}_{i} ) ,$$

contracts between agents with high versus low estimates values.

An example, a scale factor may be determined as

$${q}_{i , j}^{0} / {q}_{j , i}^{0}$$

where

$${q}_{i , j}^{0} = {\hat{Q}}_{i}^{{\overline{b}}_{- \{ i , j \}}} ( s , ( {c}_{i} , {c}_{j} ) ) and {q}_{j , i}^{0} = {\hat{Q}}_{j}^{{\overline{b}}_{- \{ i , j \}}} ( s , ( {c}_{i} , {c}_{j} ) ) .$$

This can be computed by sampling a set of M action profiles for all the agents (b̅) and then selecting the best actions for agents i and j using SAVE, and combining these using STAVE to estimate the value for agent i when no contract is agreed,

$${q}_{i , j}^{0} = {\hat{Q}}_{i}^{{\overline{b}}_{- \{ i , j \}}} ( s , ( {c}_{i} , {c}_{j} ) ) ;$$

and similarly for agent j. Thus in one example implementation the pair metric may be determined as

$${\hat{Q}}_{i}^{{B}_{- i}} ( s , {c}_{i} ) + β \frac{{q}_{i , j}^{0}}{{q}_{j , i}^{0}} {\hat{Q}}_{j}^{{B}_{- i}} ( s , {c}_{i} ) ,$$

where the weight β may be in the range [0,1] and low values of β emphasize benefit to the proposer, agent i, and vice-versa.

The multiple candidate proposed contracts that agent i could offer to agent j are denoted D_{i,j}. The process can determine which of the contracts in D_{i,j} to propose using the agreement score for actions cᵢ and cⱼ in D_{i,j}, which in implementations is based on the “no deal” first and second baseline values that the gains from agreeing contract are measured with respect to.

In one approach it is assumed that the other agents do not form agreements amongst themselves and choose actions from their respective policies π^{b} so that (continuing the previous notation)

$${d}_{1}^{0} = {\hat{Q}}_{i}^{{B}_{- \{ i , j \}}} ( s , ( {c}_{i} , {c}_{j} ) ) and {d}_{2}^{0} = {\hat{Q}}_{j}^{{B}_{- \{ i , j \}}} ( s , ( {c}_{i} , {c}_{j} ) ) .$$

These values may be estimated using the above described STAVE algorithm.

In another approach the estimates of the baseline values are determined by taking into account that other agents may be able to do better by forming agreements amongst themselves. Thus the process can consider, for each agent, what contracts might be agreed with each other agent, and then use the expected state value for the best of these as the baseline. An algorithm for this, “BATNA” (Best Alternative To a Negotiated Agreement) is given below:

```
$function MBDS - BARGAIN ( s \text{:} state , B \text{:} action profiles , {( {D}_{i , j} )}_{i , j = 1}^{n} \text{:} candidate deals ,$
          ${( {q}_{i , j}^{0} )}_{i , j = 1}^{n} \text{:} no - deal BATNA value estimates ,$
          ${( {q}_{i , j} )}_{i , j = 1}^{n} \text{:} BATNA value estimates , κ \text{:} damping factor )$
  for i ← 1 to n do
```

| | |
|---|---|
| for j ← 1 to n, j ≠ i do | [symbol] Find Nash-Bargaining Deal with j |

```
      ({cᵢ}, {cⱼ}) ← argmax _{({c}_{ᵢ}_{}, {c}_{ⱼ}_{})∈D}_{_{i, j}} NASHSCORE(s, i, j, cᵢ, cⱼ, qᵢ, _{j,} qⱼ,ᵢ, B__{{i,j}})
      ${r}_{j} ← {\hat{Q}}_{i}^{{B}_{- ( i , j )}} ( s , ( {c}_{i} , {c}_{j} ) )$
      if NASHSCORE(s, i, j, cᵢ, cⱼ, q_{i,j}, q_{j,i}, B__{{i,j}}) = 0 then rⱼ ← −∞
    for j ← 1 to n, j ≠ i do
```

| | |
|---|---|
| ${q}_{i , j}^{′} ← max ( {q}_{i , j}^{0} , {max}_{k ∈ \{ 1 , … , n \} \backslash \{ i , j \}} {r}_{k} )$ | [symbol] Find BATNA |
| q_{i,j} ← κq_{i,j} + (1 − κ)q′_{i,j} | [symbol] Apply Damping |
| $return {( {q}_{i , j}^{′} )}_{i , j = 1}^{n}$ | |

Here

$${q}_{i , j}^{0} = {d}_{1}^{0} ( and {q}_{j , i}^{0} = {d}_{2}^{0} ) ; NashScore ( s , i , j , {c}_{i} , {c}_{j} , {q}_{l , i} , {q}_{j , i ,} {B}_{- \{ i , j \}} ) = max ( 0 , {\hat{Q}}_{i}^{{B}_{− \{ i , j \}}} ( s , ( {c}_{i} , {c}_{j} ) ) − {q}_{i , j} ) \cdot max ( 0 , {\hat{Q}}_{j}^{{B}_{− \{ i , j \}}} ( s , ( {c}_{i} , {c}_{j} ) ) − {q}_{j , i} ) ;$$

and the returned baseline values are

$${( {q}_{i , j}^{′} )}_{i , j = 1}^{n} .$$

The algorithm steps through pairs of agents i, j to find pairs of actions that maximize the agreement score using no-deal estimates (“Find Nash-Bargaining Deal”), then for each pair takes a higher agreement score as a baseline if that improves on the no-deal estimate (“Find BATNA”). A damping factor, e.g. exponential smoothing, can be applied to the returned agreement values.

Each agent can choose from the contracts On The Table for them by calculating an agreement score for each, e.g. using the previously calculated baseline values, selecting a single other agent to agree a contract with. If some agreement scores are positive the contract with the highest score can be selected; otherwise an agent can select a contract that is most favorable to itself according to the expected value of the state of the environment to the agent at the next time step, provided that this value is greater than the no deal baseline (calculated as described above, e.g. using BATNA). In some implementations the process requires that a contract selected in this way is selected by both the first and second agent, i.e. that both choose D^{i→j} or both choose D^{j→i} (evaluated using the respective pair of actions cᵢ, cⱼ in each), for the contract to be agreed.

In some practical situations, e.g. when not all the agents are of the same type or when humans are involved, the restrictions in an agreed contract may be broken. It can be useful to provide an agent with an ability to sanction the behavior of another, “deviating” agent to encourage conformance. For example, a deviating agent might break a contract when it determines that it expects to gain from that. In general a sanctioning agent can modify its actions so as to attempt to lower the reward(s) of the deviating agent.

In some implementations the first agent may detect when the second agent has breached the contract, e.g. from an observation of the state of the environment (which includes the agents). The breach may occur at a time step denoted a breach time step. In response to detecting the breach the first agent may sanction the second agent. Sanctioning the second agent may comprise the first agent modifying the negotiating of a contract with the second agent for one or more time steps after the breach time step. For example the first agent may cease negotiating a contract with the second agent after the breach time step, or may modify determination of expected value of the state of the environment to the first agent at a subsequent time step, e.g. to add a term that represents a negative of the expected value of the state of the environment to the second agent at the subsequent time step (to attempt to lower the reward(s) of the deviating agent).

As an example, a modified estimate of the value of a next state, to sanction agent j with weight α, may be determined as

$${\hat{Q}}_{i - α j}^{{B}_{- i}} ( s , a ) = {\hat{Q}}_{i}^{{B}_{- i}} ( s , a ) - α {\hat{Q}}_{j}^{{B}_{- i}} ( s , a ) .$$

### In the

“Mutual Proposal” protocol this may be used to determine a modified Simulation Action Value Estimate (SAVE), used to calculate the Simulation Value Estimate (SVE). In the “Propose-Choose” protocol a similar modification may be used when choosing whether to accept a contract, e.g. in place of

$${\hat{Q}}_{j}^{{B}_{- \{ i , j \}}} ( s , ( {c}_{i} , {c}_{j} ) ) .$$

The modified estimate of the value of the next state may be extended to sanction multiple deviating agents, e.g. each with weight α.

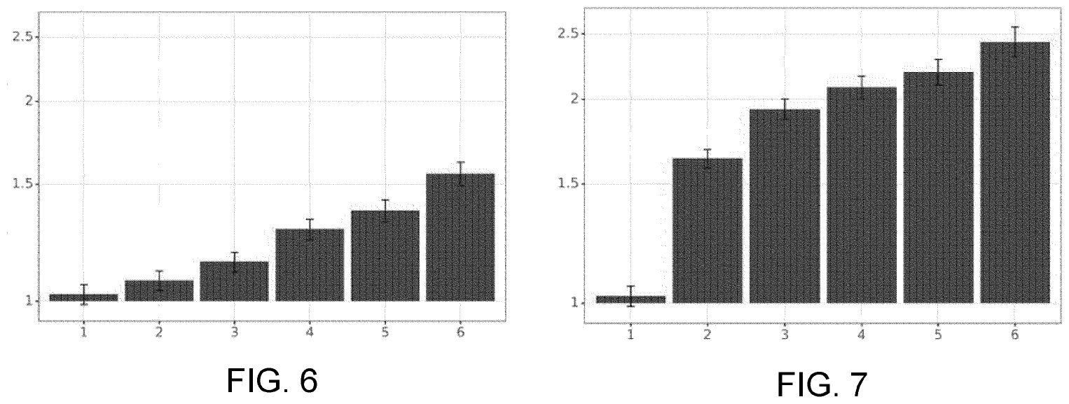

FIGS. 6 and 7 show examples of the benefits that can be achieved from implementations of the techniques. Each shows, for an example task, a total number of interacting agents on the x-axis and an improvement in return, expressed as a ratio relative to a single agent, on the y-axis. FIG. 6 is for an implementation of the Mutual Proposal protocol; FIG. 7 is for an implementation of the Propose-Choose protocol. The advantages are significant, and grow as the number of agents increases.

The described techniques are applicable, for example, to many different types of routing, scheduling, and control tasks, such as routing robots or autonomous vehicles, electrical power, or data packets; scheduling computing jobs; and controlling robots or manufacturing units or machines that interact to manufacture a product.

In some implementations the environment is a real-world environment, and at least the first agent, and in implementations each of the agents, comprises a robot or autonomous or semi-autonomous vehicle. The tasks performed by the agent or agents may then each comprise navigating a path through the environment and/or manipulating objects in the environment. The actions may comprise actions controlling movements of the agents in the environment, e.g. actions controlling a speed or direction of movement (e.g. steering) of an agent, or actions performed by the robot or autonomous vehicle such as collecting or delivering a payload such as cargo or passengers, or actions manipulating objects in the environment.

The contracts may restrict (or require) any such actions, e.g. with the aim of improving an overall efficiency of a task. For example by restricting particular agents to particular routes or by limiting a number of agents on any particular route, congestion on a route, or delivery time or energy use may be reduced. A Propose-Choose type protocol can be useful for jointly optimizing the routes of multiple agents, by defining actions for the agents.

As another example, actions relating to objects in the environment, e.g. objects to be transported by the agents, may include actions that require agents to meet and pass one or more objects from one agent to another, e.g. to exchange cargo. A contract relating to such actions, e.g. a mutually beneficial Mutual-Proposal type contract, can be useful to optimize transport of objects to their respective destinations.

The expected return, and rewards, may relate to a metric of performance of the task, such as a time or delay, or a distance to reach a destination (e.g. from the location of the agent) and/or to a physical cost of performing the task such as a fuel or energy use to reach a destination, and/or to another cost, e.g. a cost relating to congestion on one or more particular routes. In implementations the method may attempt to maximize the rewards or expected return, or to minimize the cost. For example the expected return may be dependent on rewards received for moving along a path e.g. within a particular time or dependent on a speed of motion of the agent, or for less than a particular energy use by the agent.

The state of the environment, which includes the agents, may be characterized by state representations that are derived from observations of the environment using any type of sensor, e.g. an image or video sensor (which here includes a LIDAR sensor); or sensors of the agent state, position; or configuration, or sensors of the environment such as sensors of states, positions or configurations of one or more other agents; or, e.g., sensors of average speed of agent movement; or a congestion sensor, e.g. to sense congestion on one or more possible routes that the agents are able to select; or sensors of the locations of static or dynamic objects such as trees, buildings, pedestrians, or traffic lights; or map data e.g. defining possible routes an agent may take; or generally sensors or devices capturing data relating to the state, position or configuration of objects in the environment.

As an example the task performed by the agents may comprise delivery of a payload such as cargo, e.g. one or more packages, or passengers. For example the agents may cooperate to deliver the payload to multiple different destinations in an energy-efficient manner and/or avoiding mutual congestion in transit or on arrival (e.g. by defining a minimum time interval between deliveries to a particular destination). A contract may relate to actions such as determining which agent is to deliver which item and/or to which destination, or to routes to take or avoid.

As one particular example the agents may comprise robots or vehicles performing a task such as warehouse, logistics, or factory automation, e.g. collecting, placing, or moving stored goods or goods or parts of goods during their manufacture.

As another example the agents may comprise electric taxis and the agents may determine contracts that enable the taxis to cooperate in collection and delivery of passengers in a time- and energy-efficient manner, e.g. taking account of available range.

As another example the agents may comprise cars or trucks and the agents may determine contracts that enable the vehicles to cooperate when moving on a road, e.g. to facilitate smooth and safe traffic flow by defining the rewards that aim to maintain a maximum, minimum or target distance between the vehicles.

As another example the vehicles may be airborne vehicles such as drones. In an agricultural setting, for example, the task(s) may then comprise delivery of payloads such as pesticide, seed, water, or fertilizer to plants. In an emergency response setting the tasks may comprise searching for a person. In another setting the tasks may comprise package delivery tasks.

In general the described technology may be used to manage large numbers of robots or autonomous or semi-autonomous vehicles operating on land, in the air, or on water. In general the previously-described simulator may simulate the effects of the actions of the agents, e.g. vehicles, in the environment. For example the simulator could take in the current state and agent actions, and output data characterizing the next state. For example the current state and agent actions could comprise the current locations of agents, and choices regarding the routes taken by agents (e.g. turning left at an intersection leads to a vehicle using one road instead of the other), and the simulator could then determine a congestion level on each road, and the resulting travel times.

The actions, and contracts, may relate to low-level, intermediate-level, or high-level actions. Examples of high level actions include actions that specify locations that a robot or vehicle should move to or avoid; examples of intermediate level actions include actions that specify which robot or vehicle is to move first, or has priority, at a junction or intersection of routes. Low-level actions could specify a particular speed or direction for an agent. In general the rewards defining the expected return can be based on an event or an aspect of the environment. For example, a reward may indicate whether an agent has accomplished a task as described above, or the progress of the agent towards accomplishing the task (the particular rewards correspond to the above tasks and are therefore not repeated for conciseness).

In some implementations the environment is an environment is a computing environment, and each of the agents comprises a computing job scheduling agent e.g. a software agent that manages distribution of compute tasks across computing resources e.g. on a mobile device or in a computer or on a computer cluster, or in a data center. The computing resources may comprise various hardware resources. The resources may comprise different low level resources such as processors with different capabilities, e.g. one or more general purpose processors (CPUs), or GPUs (Graphics Processing Units), or TPUs (Tensor Processing Units), or different intermediate level resources such as different computers that work together in a computer cluster, or different higher level resources such as servers in a data center. The hardware resources may, but need not have, different computational or memory capabilities. The tasks performed by the agents may comprise executing computer programs. The actions may comprise actions allocating one or more computing jobs associated with the tasks to one or more computing hardware resources. The contracts may restrict such actions e.g. to restrict the availability of hardware computing resources to a particular agent e.g. by time or type of resource, or to require a particular agent to use a particular resource. The expected return, and rewards, may relate to a metric of performance of a task such as a time to complete a task, or the computational cost of performing the task (e.g. where this depends on the hardware on which it is implemented), or the power or energy cost of performing a task, or the reliability of performing a task (e.g. where a task is repeated for fault-tolerance). The state of the environment may be characterized by state representations that are derived from observations of the computing environment, e.g. a computational workload on a hardware resource, memory usage/availability e.g. for a hardware resource, a physical state, such as temperature, of a hardware resource, or whether a hardware resource is exhibiting a fault. The contracts may e.g. relate to scheduling computing jobs, e.g. to control the allocation of the computing jobs to the hardware resources. The simulator may simulate the effects of the actions in the environment, e.g. the effects of allocating particular computing jobs to particular resources.

In some implementations the environment is a packet communications network environment and the agents each comprise a router to route packets of data over the communications network. The tasks performed by the agents may then comprise packet routing tasks. The actions may comprise routing actions to route the packets of data e.g. actions to determine a next or further destination for one or more data packets. The contracts may restrict these actions, e.g. to coordinate packet transmission and reduce congestion, and generally to control the routing of the packets of data over the communications network. The expected return, and rewards, may relate to one or more packet routing metrics e.g. relating to a path from the router to a next or further node in the data packet communications network. Such metrics may include, e.g., an estimated time, delay, speed, distance, or hop count for a group of one or more routed data packets to travel from the router to the next or further node in the data packet communications network, a measurement of route utilization, a route packet loss or other reliability measure, a route bandwidth or throughput, or a route maximum transmission unit (MTU). The state of the environment may be characterized by state representations that are derived from observations of available data packet routes and their characteristics e.g. characteristics corresponding to the aforementioned metrics. For example the observations may include observations of a routing table of the router. The simulator may simulate the effects of different choices of route. The environment of a packet communications network is in some respects similar to the previously described real-world environment in which moving agents are routed and concepts of that domain can be correspondingly applied to a packet communications network.

In some implementations the environment is an electrical power distribution environment, and the agents are each configured to control routing of electrical power from an electrical power distribution node, e.g. a node associated with the agent, to one or more other nodes over one or more power distribution links, e.g. in a “smart grid”.

As electrical power distribution grids become more decentralized, for example because of the addition multiple smaller capacity, and potentially intermittent renewable power generators, the additional interconnections amongst the power generators and consumers can destabilize the grid and can cause overload of a link in the grid, particularly because of phase differences between connected points.

The tasks performed by the agents comprise tasks that distribute power from a power generator to power consumers. The actions comprise control actions to control the routing of electrical power between the nodes. For example the actions may comprise actions to connect or disconnect sources or sinks of electrical power to the grid, or actions controlling the routing of electrical power over links between nodes of the grid, or actions controlling a frequency or phase of an electrical power generator, or actions controlling a frequency mismatch or phase mismatch between elements of the grid, e.g. connected via a node. The described contracts can coordinate these actions e.g. to increase stability and reduce the risk of overload of a power grid; and generally can relate to controlling the routing of the electrical power. The expected return, and rewards, may relate to one or more electrical power routing metrics e.g. relating to an electrical power loss within the grid, or to a frequency or phase mismatch over one or more of the power distribution links, or to a risk of overloading or failure or to a risk of exceeding a threshold on one or more of the power distribution links.

The state of the environment may be characterized by state representations that are derived from observations from sensors sensing a state of the power grid, e.g. sensing frequency, phase, current, voltage, electrical loading, resistance or impedance associated with one or more connections between the nodes, or static observations of a configuration of the power grid e.g. of elements coupled to the grid and power distribution links. The simulator may simulate the effects of different choices of electrical power control or routing actions.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units may be configured such that an intermediate version or component of the product is moveable between the manufacturing units during manufacture of the product, e.g. via pipes or mechanical conveyance.

In such implementations at least the first agent, and in implementations each of the agents, comprises a control system configured to control manufacture of a mechanical, chemical, or biological product. For example the control system may be configured to control one or more of the manufacturing units or machines or to control movement of an intermediate version or component of the product between the manufacturing units or machines. In general the manufacturing units or machines interact to manufacture the product. In general the task(s) performed by the agent or agents comprises a task to manufacture the or another mechanical, chemical, or biological product or intermediate or component thereof. That is the agents may interact to control manufacture of the same product, or they may control the manufacture of different products. As used herein manufacture of a product includes manufacture of a food product by one or more kitchen robots.

The actions may comprise control actions to control the use of a machine or a manufacturing unit for processing a solid or liquid material to manufacture the product or intermediate or component thereof, or to control movement of an intermediate version or component of the product within the manufacturing environment e.g. between the manufacturing units or machines. In general the actions may be any actions that have an effect on the observed state of the environment, i.e. actions configured to adjust any of the sensed parameters described below. These may include actions to adjust the physical or chemical conditions of a manufacturing unit, or actions to control the movement of mechanical parts of a machine or joints of a robot, or actions to control the movement of material between manufacturing units. The contracts may restrict such actions with the aim of improving the efficiency of manufacturing, e.g. by reducing competition for use of a manufacturing unit or machine; and generally can control the manufacturing conditions and/or movement of materials within the manufacturing environment. Again aspects of this domain are similar to the previously described domains, and corresponding concepts apply.

The expected return, and rewards, may relate to a metric of performance of the task such as a metric of a quantity of the product that is manufactured, a quality of the product, a speed of production of the product, or to a physical cost of performing the manufacturing task, e.g. a metric of a quantity of energy, materials, or other resources, used to perform the task.

The state of the environment may be characterized by state representations that are derived from observations from sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment. The simulator may simulate the effects of the different choices of the aforementioned actions in the manufacturing environment.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a relationship graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method of controlling a first agent to perform a task in an environment in which the first agent interacts with one or more other agents performing one or more other tasks,
wherein the first agent has an action selection subsystem configured to process a state representation characterizing a state of the environment to generate a policy output for selection of an action to be performed by the agent, and a value neural network configured to process the state representation to determine a state value, wherein the state value defines an expected return for the agent from the state of the environment characterized by the state representation;
wherein the first agent, at each of a plurality of time steps:
obtains a state representation characterizing the state of the environment at a current time step;
processes the state representation using the action selection subsystem for the agent to generate the policy output for the first agent;
determines predicted actions of the other agents using the state representation; and
selects an action for the first agent to perform using the policy output for the first agent and dependent upon the predicted actions of the other agents;
the method comprising, at one or more of the time steps:
the first agent negotiating a contract with a second agent, wherein the second agent is one of the other agents, the contract defining a restriction on the actions that may be selected by the first agent and a restriction on the actions that may be selected by the second agent;
wherein negotiating the contract comprises the first agent determining whether to propose a contract by:
determining one or more scores that represent an expected value of the state of the environment to the first agent at a subsequent time step with and without the proposed contract by simulating effects of future actions of the first agent and of the other agents i) without the proposed contract and ii) taking into account the effect of the restriction on the actions in the proposed contract, and
communicating the proposed contract to the second agent dependent on the score or scores; and
in response to receiving an indication of acceptance of the proposed contract from the second agent, selecting an action for the first agent to perform taking into account the restriction on the actions of the first agent in the proposed contract.

2. The method of claim 1 further comprising the first agent determining whether to accept the proposed contract; and wherein selecting the action for the first agent taking into account the restriction on the actions of the first agent in the proposed contract is further contingent on the first agent accepting the proposed contract.

3. The method of claim 1, wherein determining the expected value of the state of the environment to the first agent at the subsequent time step comprises sampling one or more possible actions of the first agent at the time step using the action selection subsystem and, for each of the one or more actions and for each of the other agents:
sampling a plurality of possible actions of the other agent at the time step; and
determining, using the value neural network, the state value for a predicted new state of the environment determined by the sampled actions of the agents; and wherein
simulating the effects of the future actions comprises averaging the state value for each predicted new state over the sampled actions for each of the other agents to determine the expected value of the state of the environment to the first agent for each of the one or more sampled possible actions of the first agent.

4. The method of claim 1, wherein simulating the future actions of the agents comprises, for each agent:
selecting a set of one or more candidate actions for the agent by i) using the action selection subsystem, and or ii) where the proposed contact applies to the agent, by applying the restriction on the actions in the proposed contract.

5. The method of claim 1, wherein the contract defines a class of actions that define the same or corresponding restrictions on the actions that may be selected by both the first agent and the second agent; the method further comprising:
determining a first score that represents an expected value of the state of the environment to the first agent at a subsequent time step with the proposed contract and a second score that represents an expected value of the state of the environment to the first agent at a subsequent time step without the proposed contract;
comparing the first score and the second score; and
determining to communicate the proposed contract when the first score exceeds the second score.

6. The method of claim 1, wherein the contract defines a first action that must be selected by the first agent and a second action that must be selected by the second agent; wherein the one or more scores comprise an agreement score that represents an expected value of the state of the environment to both the first agent and the second agent at the subsequent time step when the first agent and the second agent respectively select the first action and the second action, the method further comprising:
determining respective first and second baseline values that represent the expected value of the state of the environment to, respectively, the first agent and the second agent at the subsequent time step, without restricting the second agent to the second action and without restricting the first agent to the first action; and
determining the agreement score with respect to the baseline values.

7. The method of claim 6 wherein the agreement score comprises a product of i) a difference between the expected value of the state of the environment to the first agent at the subsequent time step when the first agent and the second agent respectively select the first action and the second action, and the first baseline value; and ii) a difference between the expected value of the state of the environment to the second agent at the subsequent time step when the first agent and the second agent respectively select the first action and the second action, and the second baseline value.

8. The method of claim 6 wherein the first baseline value comprises the expected value of the state of the environment to the first agent at the subsequent time step when the first agent selects the first action and the action selected by the second agent is unrestricted; and wherein the second baseline value comprising the expected value of the state of the environment to the second agent at the subsequent time step when the second agent selects the second action and the action selected by the first agent is unrestricted.

9. The method of claim 6,
wherein determining the first baseline value comprises, for each pair of agents except for the pair comprising the first agent and the second agent, identifying whether they would agree a contract for the subsequent time step and, when they would agree a contract, determining the first baseline value as the expected value of the state of the environment to the first agent at the subsequent time step as if the agreed contract was in place; and
wherein determining the second baseline value comprises, for each pair of agents except for the pair comprising the first agent and the second agent, identifying whether they would agree a contract for the subsequent time step and, when they would agree a contract, determining the second baseline value as the expected value of the state of the environment to the second agent at the subsequent time step as if the agreed contract was in place.

10. The method of claim 6, further comprising determining the proposed contract for the second agent by determining a plurality of candidate proposed contracts and selecting a candidate proposed contract with the highest agreement score as the proposed contract.

11. The method of claim 6, further comprising determining the proposed contract for the second agent by determining a plurality of candidate proposed contracts and selecting one of the candidate proposed contracts as the proposed contract, wherein determining the candidate proposed contracts comprises:
determining a first set of candidate actions for the first agent by processing the state representation at the current time step using the action selection subsystem to generate the policy output for the first agent;
determining a second set of candidate actions for the second agent by processing the state representation at the current time step using the action selection subsystem to generate the policy output for the second agent;
generating pairs of actions comprising a first candidate action from the first set of candidate actions and a second candidate action from the second set of candidate actions; and
determining the candidate proposed contracts by selecting a set of candidate pairs of actions by ranking the pairs of actions according to a pair metric, and selecting the K highest ranked pairs of actions;
wherein each candidate proposed contract comprises one of the candidate pairs of actions; and
wherein the pair metric for a pair of actions comprises a combination of the expected value of the state of the environment to the first agent at the subsequent time step when the first agent performs the first candidate action in the pair of actions, and the expected value of the state of the environment to the second agent at the subsequent time step when the second agent performs the second candidate action in the pair of actions.

12. The method of claim 11 wherein the combination is a weighted combination to weight a value of the proposed contract to the second agent.

13. The method of claim 1, further comprising:
detecting, by the first agent, that the second agent has breached the contract at a breach time step; and, in response,
sanctioning the second agent, wherein the sanctioning comprises the first agent modifying the negotiating of a contract with the second agent at a time step after the breach time step.

14. The method of claim 1, wherein the environment is a real-world environment, wherein at least the first agent comprises a robot or autonomous vehicle, wherein the task and the other tasks each comprises navigating a path through the environment, wherein the actions comprise actions controlling movements of the agents in the environment, and wherein the expected return relates to a metric of one or more of: performance of the task; and a physical cost of performing the task.

15. The method of claim 1, wherein the environment is a computing environment, wherein each of the agents comprises a computing job scheduling agent, wherein the task and the other tasks each comprises executing a computer program, wherein actions comprise actions allocating one or more jobs to one or more computing hardware resources, and wherein the expected return relates to a metric of time to perform the task, an energy cost of performing the task, a computational cost of performing the task, and a reliability of performing the task.

16. The method of claim 1, wherein the environment is a packet communications network environment, wherein each of the agents comprises a router to route packets of data over the communications network, wherein the task and the other tasks each comprises a packet routing task, wherein actions comprise routing actions to route the packets of data, and wherein the expected return relates to one or more packet routing metrics.

17. The method of claim 1, wherein the environment is an electrical power distribution environment, wherein each of the agents is configured to control routing of electrical power from a node associated with the agent to one or more other nodes over one or more power distribution links, wherein the task and the other tasks each comprises a task to distribute power from a power generator to power consumers, wherein actions comprise control actions to control the routing of electrical power between the nodes, and wherein the expected return relates to a loss on one of the power distribution links, or to a frequency or phase mismatch in relation to one of the power distribution links, or to overloading one of the power distribution links.

18. The method of claim 1, wherein the environment is a real-world manufacturing environment, wherein at least the first agent comprises a control system configured to control manufacture of a mechanical, chemical, or biological product, wherein the task and the other tasks each comprises a task to manufacture the or another mechanical, chemical, or biological product or intermediate or component thereof, wherein actions comprise control actions to control the use of a machine or a manufacturing unit for processing a solid or liquid material to manufacture the product or intermediate or component thereof, or to control movement of the product or intermediate or component thereof within the manufacturing environment, and wherein the expected return relates to a metric of one or more of: performance of the task; and a physical cost of performing the task.

19. One or more non-transitory computer storage media storing computer-readable instructions that when executed by one or more computers cause the one or more computers to perform operations for controlling a first agent to perform a task in an environment in which the first agent interacts with one or more other agents performing one or more other tasks,
wherein the first agent has an action selection subsystem configured to process a state representation characterizing a state of the environment to generate a policy output for selection of an action to be performed by the agent, and a value neural network configured to process the state representation to determine a state value, wherein the state value defines an expected return for the agent from the state of the environment characterized by the state representation;
wherein the first agent, at each of a plurality of time steps:
obtains a state representation characterizing the state of the environment at a current time step;
processes the state representation using the action selection subsystem for the agent to generate the policy output for the first agent;
determines predicted actions of the other agents using the state representation; and
selects an action for the first agent to perform using the policy output for the first agent and dependent upon the predicted actions of the other agents;
the operations comprising, at one or more of the time steps:
the first agent negotiating a contract with a second agent, wherein the second agent is one of the other agents, the contract defining a restriction on the actions that may be selected by the first agent and a restriction on the actions that may be selected by the second agent;
wherein negotiating the contract comprises the first agent determining whether to propose a contract by:
determining one or more scores that represent an expected value of the state of the environment to the first agent at a subsequent time step with and without the proposed contract by simulating effects of future actions of the first agent and of the other agents i) without the proposed contract and ii) taking into account the effect of the restriction on the actions in the proposed contract, and
communicating the proposed contract to the second agent dependent on the score or scores; and
in response to receiving an indication of acceptance of the proposed contract from the second agent, selecting an action for the first agent to perform taking into account the restriction on the actions of the first agent in the proposed contract.

20. A system comprising one or more computers and one or more storage devices storing instructions that when executed by one or more computers cause the one or more computers to perform operations for controlling a first agent to perform a task in an environment in which the first agent interacts with one or more other agents performing one or more other tasks,
wherein the first agent has an action selection subsystem configured to process a state representation characterizing a state of the environment to generate a policy output for selection of an action to be performed by the agent, and a value neural network configured to process the state representation to determine a state value, wherein the state value defines an expected return for the agent from the state of the environment characterized by the state representation;
wherein the first agent, at each of a plurality of time steps:
obtains a state representation characterizing the state of the environment at a current time step;
processes the state representation using the action selection subsystem for the agent to generate the policy output for the first agent;
determines predicted actions of the other agents using the state representation; and
selects an action for the first agent to perform using the policy output for the first agent and dependent upon the predicted actions of the other agents;
the operations comprising, at one or more of the time steps:
the first agent negotiating a contract with a second agent, wherein the second agent is one of the other agents, the contract defining a restriction on the actions that may be selected by the first agent and a restriction on the actions that may be selected by the second agent;
wherein negotiating the contract comprises the first agent determining whether to propose a contract by:
determining one or more scores that represent an expected value of the state of the environment to the first agent at a subsequent time step with and without the proposed contract by simulating effects of future actions of the first agent and of the other agents i) without the proposed contract and ii) taking into account the effect of the restriction on the actions in the proposed contract, and
communicating the proposed contract to the second agent dependent on the score or scores; and
in response to receiving an indication of acceptance of the proposed contract from the second agent, selecting an action for the first agent to perform taking into account the restriction on the actions of the first agent in the proposed contract.
